(19) United States
(12) Patent Application Publication
(10) Pub. No.: US 2009/0069045 A1
(43) Pub. Date: Mar. 12, 2009

(54) Wrist-watch mobile phone

(76) Inventor: Ta-Peng Cheng, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/230,830

(22) Filed: Sep. 5, 2008

(30) Foreign Application Priority Data
Sep. 12, 2007 (TW) 096133997

(51) Int. Cl. H04M 1/00

(52) U.S. Cl. 455/556.1; 455/556.2

(57) ABSTRACT

A wrist-watch mobile phone device which is recharged by body temperature to prevent from signal interruption includes a wrist-watch mobile phone unit which is applied in a cellular wireless communication system, and a wrist band which is assembled with the wrist-watch mobile phone unit. The mobile phone unit includes a housing which is provided with wrist-band installation members and a cover which is pivoted at the housing and can be flipped open freely. A rear side of the housing that is in contact with a human arm is embedded with thermoelectric power generating chips to recharge a primary battery of the mobile phone at any time by body temperature of the arm. In addition, a surface or a part of the cover is provided with an independent system of a quartz-core watch to facilitate reading time.

### BACKGROUND OF THE INVENTION

a) Field of the Invention

The present invention relates to a mobile phone, and more particularly to a wrist-watch mobile phone which can be worn on a wrist. The present invention also relates to a PDA (Personal Digital Assistant) mobile phone which can be worn on the wrist.

b) Description of the Prior Art

As prosperous development of wireless communication industries, continuous renovation of technologies for developing related 3C (Computing, Communication and Consumer) products, and popularity of a personal portable mobile phone (or the so-called hand phone), it can be expected that everyone can has a mobile phone in developed countries.

The mobile phone is small and light-weight, hence, a male user will usually put it in a pocket on a shirt and a female user will usually put it in a hand bag. If there is no pocket on clothes or the user does not carry any bag, then people, disregarding gender, will usually hold it in a hand, put it in a hand phone case and then hang it on the hand, or hang it on a neck with a strap. For the aforementioned carrying methods, as both hands are usually separated from the hand phone after using the hand phone for dialoging or when both hands are used in working, it is very easy to forget where the hand phone is or even to lose the hand phone due to negligence or inattention.

On the other hand, when the mobile phone is used frequently, it should be powered off for recharging constantly; otherwise it cannot be used. Sometimes, communication will be interrupted by insufficient electricity due to that the mobile phone has been used too long continuously, thereby resulting in all kinds of inconvenience. Furthermore, a digital or analog clock displayed on a liquid crystal display of the mobile phone is easily affected by strong daylight that it is not easy to read time clearly.

The Taiwanese New Utility Publication No. 425021 discloses a “wrist-type mobile phone case,” which is only a case, a middle part of an enclosure member of which is provided with a pocket for placing the mobile phone, and two sides of the enclosure member are provided with tie straps, such that the wrist can be enclosed by the enclosure member and the mobile phone can be put in the pocket, allowing the mobile phone to be worn on the wrist for carrying personally. However, this kind of telephone case is like an ordinary hand phone case or hand phone bag, and is only an external accessory that is dispensable; therefore, it is not directly related to the structure and functions of the mobile phone at all.

The Taiwanese Invention Publication No. 454408, “wireless telephone stopwatch with a subscriber identification module card,” discloses a wireless telephone stopwatch that can be worn on the user's wrist. Yet, a primary characteristic of this invention is to load a portable SIM (Subscriber Identification Module) card on a part of a wrist band; that is, a frame device of the subscriber identification module is connected to an electronic module of the stopwatch. Accordingly, this stopwatch does not disclose any concrete structure or configuration of parts.

The Taiwanese Invention Publication No. 561745, “information gateway system and method,” discloses a communication system which includes a sub network. The sub network is provided with a dedicated primary device to execute primary functions, a secondary device, and another device which links the secondary device to the primary device with a first communication path and is coupled to the sub network, such that messages can be transmitted to the secondary device from the primary device through this another device. This patent publication also discloses that the secondary device can be a watch-type phone or a pen-type phone, which is only represented by abstract schematics without any specific description of an assembly of internal and external structures.

The Taiwanese Invention Publication No. 515189 discloses a portable object which is provided with a stopwatch function and a telephone set, used primarily to make telephone communication with a dedicated server, so as to transmit and receive a data signal for adjusting or updating the stopwatch function of the object, thereby calibrating the stopwatch function. In other words, that object is a kind of wireless automatic calibration watch. Although the publication describes that the object includes a mobile phone unit which is connected to a microphone and an earphone, no further disclosure of a specific design of structures is shown on the drawings.

In spite that all kinds of mobile phone devices disclosed in the aforementioned publications can implement a total or a part of communication functions of wireless transmission and receiving, none of the prior arts has mentioned a specific implementation of structures. Especially, a concept that a watch cover is provided with an independent system of a dial-type quartz-core watch, and a housing or a rear side of a wrist band is provided with a thermoelectric power generating chip to assist recharging a primary battery at any time by body temperature, so as to prevent signals from being interrupted or to extend a lifetime of usage of the battery, has never been disclosed or proposed.

As an assembly and modules of the mobile phone are becoming more and more sophisticated and compact, it is not difficult to make a wrist-watch hand phone that is worn on the hand to directly receive and transmit telephone information, due to entire miniaturization of the mobile phone.

### SUMMARY OF THE INVENTION

The primary object of the present invention is to provide a wrist-watch mobile phone which includes a wrist-watch mobile phone unit and a wrist band that is connected to this wrist-watch mobile phone unit, wherein a surface of a housing and/or of the wrist band of the wrist-watch mobile phone unit that is in contact with a human wrist is embedded with a thermoelectric power generating chip to recharge a battery of the mobile phone unit by body temperature, so as to avoid complete signal interruption while using the mobile phone, or at least to extend a lifetime of usage of the battery.

A second object of the present invention is to provide a wrist-watch mobile phone which is provided with the aforementioned recharging system of the thermoelectric power generating chip, wherein a surface of an upper cover is embedded with an independent system of a quartz-core dial-type watch to facilitate a user to read time under strong light.

A third object of the present invention is to provide a wrist-watch PDA mobile phone which includes a watch-type PDA mobile phone unit and a wrist band that is connected to the watch-type PDA mobile phone unit, wherein a surface of a housing and/or of the wrist band of the PDA mobile phone unit that is in contact with a human wrist is embedded with a thermoelectric power generating chip to recharge a battery of the PDA mobile phone unit by body temperature, so as to avoid complete signal interruption while using the PDA mobile phone, or at least to extend a lifetime of usage of the battery

A fourth object of the present invention is to provide a wrist-watch PDA mobile phone which is provided with the aforementioned recharging system of the thermoelectric power generating chip, wherein a surface of an upper cover is embedded with an independent system of a quartz-core dial-type watch to facilitate the user to read time under strong light.

Accordingly, the wrist-watch mobile phone device of the present invention is constituted by a wrist-watch mobile phone unit which is applied in a cellular wireless communication system, and a wrist band which is assembled with the wrist-watch mobile phone unit. The mobile phone unit includes a housing which is provided with wrist band installation members and a cover which is pivoted on the housing and can be lifted open freely, wherein at least a rear side of the housing that is in contact with a human arm is embedded with a thermoelectric power generating chip to recharge a primary battery of the mobile phone at any time by body temperature of the arm. On the other hand, a surface of the cover is embedded with an independent system of a quartz-core watch to facilitate utilization.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a perspective view of a first embodiment of a wrist-watch mobile phone, in accordance with the present invention;

FIG. 2 is a perspective view of a state showing a cover of a mobile phone has been lifted open and a wrist band has been released as in FIG. 1;

FIG. 3 shows a cutaway view of a mobile phone as in FIG. 1, representing an example of an internal structure;

FIG. 4 is flow charts of a thermoelectric power generating chip which recharges a rechargeable battery to provide electricity;

FIG. 5 is a perspective view of a second embodiment of a mobile phone, in accordance with the present invention;

FIG. 6 is a perspective view of a state showing a cover of a mobile phone has been lifted open as in FIG. 5;

FIG. 7 is a perspective view of a third embodiment of a mobile phone, in accordance with the present invention;

FIG. 8 is a perspective view of a state showing a cover of a mobile phone has been lifted open as in FIG. 7;

FIG. 9 is a perspective view of a fourth embodiment of a mobile phone, in accordance with the present invention;

FIG. 10 is a perspective view of a state showing a cover of a mobile phone has been lifted open as in FIG. 9;

FIG. 11(A) shows a schematic view of using a first embodiment of a mobile phone, in accordance with the present invention;

FIG. 11(B) shows another schematic view of using a first embodiment of a mobile phone, in accordance with the present invention;

FIG. 12(A) shows a schematic view of using a third embodiment of a mobile phone, in accordance with the present invention;

FIG. 12(B) shows another schematic view of using a third embodiment of a mobile phone, in accordance with the present invention.

### DETAILED DESCRIPTION OF THE PREFERRED EMBODIMENTS

### First Embodiment

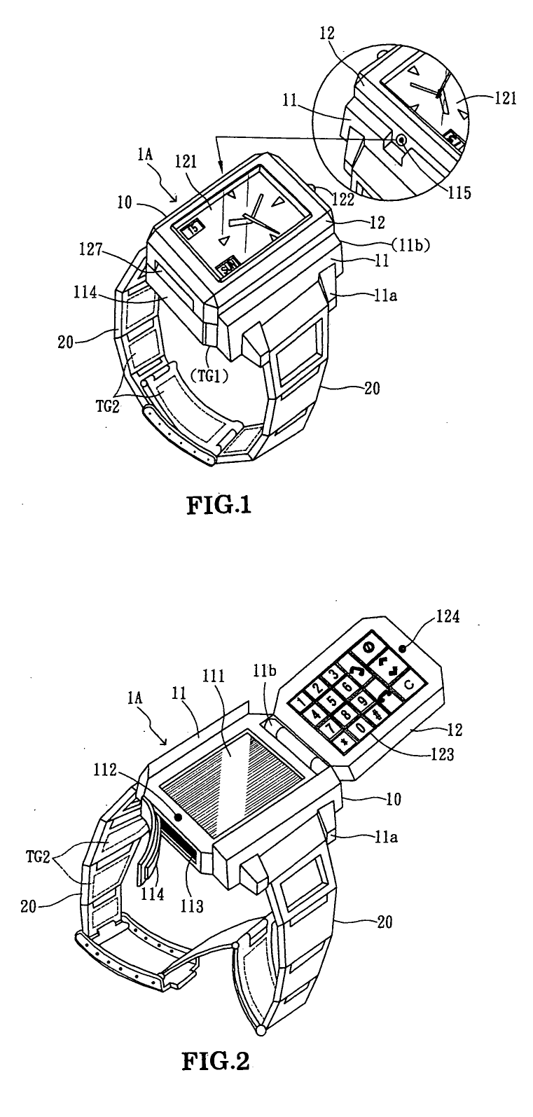

Referring to FIGS. 1 to 3, a wrist-watch mobile phone 1A of a first embodiment of the present invention comprises primarily a portable mobile phone unit (hand phone) 10 which receives and transmits signals for two-way wireless communication in a mobile communication system, and a wrist band 20 which can be removably connected on the mobile phone unit 10 to be worn on a wrist.

The mobile phone unit 10 basically constitutes a so-called shell-type hand phone which is a portable wireless mobile phone having a flip structure, including a housing 11, two sides of which are provided with a pair of wrist-band installation members 11a, and a cover 12 which can be pivoted on a side of the housing 11 without the wrist-band installation members 11a by a hinge 11b to open and close freely a surface of the housing 11.

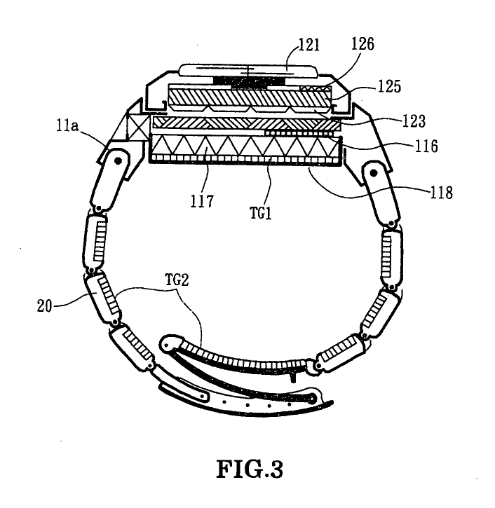

The surface of the housing 11 is provided with a liquid crystal display (LCD) 111, a microphone 112 is provided on the housing 11 below the display 111 and at an opposite side to the hinge 11b, and an end surface of the housing 11 that is closely adjacent to the microphone 112 is provided with an interface 113 to recharge and transmit information to other devices, such as a computer. In order to prevent rain water from intruding into the interface 113, an exterior of the interface 113 is designed as a groove and is latched with a water-proof rubber strip 114 to seal a slot opening of the interface 113. Furthermore, a side of the housing 11 without the wrist-band installation members 11a is provided with a camera lens 115. An interior of the housing 11, as shown in FIG. 3, is provided with a SIM card 116 and a rechargeable battery 117 which can be removed by taking down a bottom seat or a bottom cover 118 of the housing 11, like an ordinary hand phone. A bottom surface of the bottom seat or the bottom cover 118 is provided with a primary thermoelectric power generating chip TG1 to assist recharging the battery 117 by wrist temperature, such that signal interruption of the mobile phone 1A can be avoided and a usable time of the battery 117 can be prolonged.

A surface of the cover 12 is provided with a quartz-core watch 121, allowing the mobile phone unit 10 to look like a watch in a whole, using dials to represent time (hour, minute and second), and preferably being provided with a window to display “date” and “week” that a wearer can read the date, week, hour, minute and second. It is well known that the dials, numbers and texts of a quartz watch are less affected by strong light in a day light than a digital or analog display of an LCD (Liquid Crystal Display), and a rough time can be read by one glance. Therefore, using this quartz-core watch 121 has a special meaning. A knob 122 to adjust the date and time of the quartz watch 121 is provided at a side of the housing 12 with the hinge 11b, but it is also acceptable if the knob 122 is provided at the side of the housing 11 with the wrist-band installation members 11a. An interior surface of the cover 12 that is connected to the display 111 of the housing 11 is provided with a keyboard 123 to input information, and a free end of the same surface is provided with an earphone 124 to receive voices. On the other hand, inside the cover 12 and between the keyboard 123 and the quartz watch 121 is provided with a main circuit board 125 for wireless communication and a dedicated battery 126 for the quartz watch 121. Moreover, to facilitate flipping open the cover 12, the free end of the cover 12 is provided with a flip groove 127.

The wrist band 20 is fixed at the wrist-band installation members 11a of the housing 1 by two ends, as an ordinary watch band. This wrist band 20 is made by a metal and an interior is embedded with secondary thermoelectric power generating chips TG2 to assist the primary thermoelectric power generating chip TG1 to recharge the battery 117; or, at least one of the secondary thermoelectric power generating chips TG2 can be used to directly recharge the quartz watch battery (secondary battery) 126 by providing a standard current to the quartz watch 121.

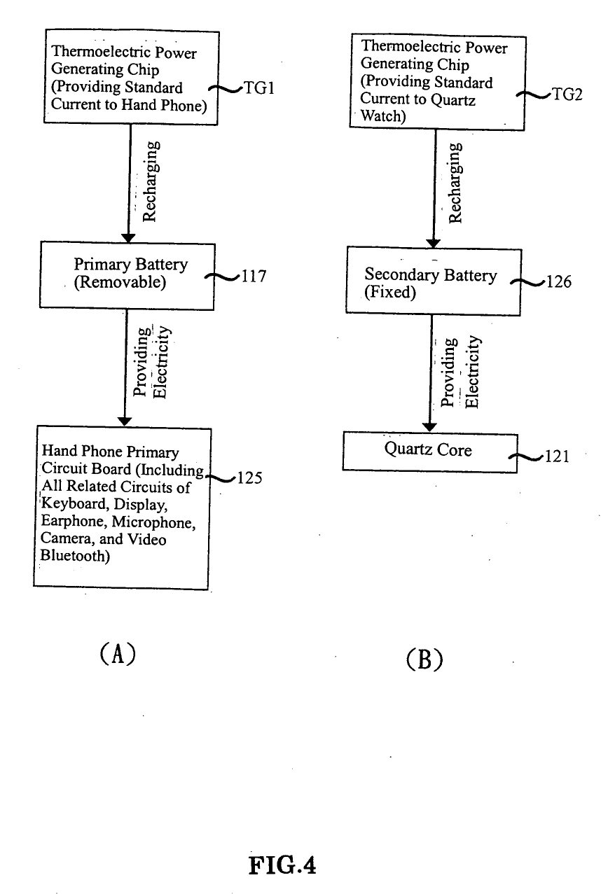

It is preferably to design a recharging mechanism of the thermoelectric power generating chips TG1, TG2 as two independent systems, as shown in FIG. 4(A) and FIG. 4(B), due to that a voltage and a current used by a hand phone (mobile phone) are not same as those used by a quartz watch. To be more specific, the first thermoelectric power generating chip TG1 is used to provide a standard current of the hand phone to assist recharging the primary battery 117 at any time, so as to prolong and maintain normal electricity of the primary battery 117. This primary battery 117 still needs to be taken down from the hand phone to be recharged from a normal house socket, at a constant time period or when the watch is not worn. The primary battery 117 will then directly provide electricity to the hand phone circuit board 125 and the display 111. Another accessory recharging method is to use the thermoelectric power generating chip TG1 to directly provide electricity to the primary battery 117 which is not provided with sufficient electricity, only for maintaining temporary communication, in accordance with the primary communication function. As an auxiliary recharging capacity of this chip TG1 is limited, the hand phone can be designed to be that when the primary battery 117 is not providing sufficient electricity, the display 111 will show a message like “the chip is activated to recharge with body temperature,” and other accessory functions, such as a camera and a video signal, should be deactivated to prevent from interfering with the communication function. At least one of TG2 is used specifically to recharge the secondary battery, that is, the quartz watch battery 126, by providing a standard current to the quartz watch 121. This battery 126 is immobilized and cannot be taken down, and provides electricity to the quartz-core watch 121 to drive the dials.

Using two sets of different thermoelectric power generating chips TG1, TG2 to recharge respectively the primary battery 117 and the secondary primary 126, it is not necessary to add a current and voltage converter circuit, allowing the main circuit board 125 to be simplified. However, in the other recharging mechanism, although not shown in the drawings, it is also acceptable that a current at a shunt part recharges the secondary battery 126 to actuate the quartz watch 121 after passing through the current and voltage converter circuit, if all of the thermoelectric power generating chips TG1, TG2 recharge the primary battery 117. As the quartz watch 121 consumes very few electricity, the secondary battery 126 of sufficient capacity can be used for a long time; whereas, the primary battery 117, which consumes more electricity, can continue to provide electricity to the secondary battery 126 after being recharged completely. Therefore, the dial function of the quartz watch 121 will not be interrupted by insufficient capacity of the primary battery 117 or by taking down the primary battery 117.

### Second Embodiment

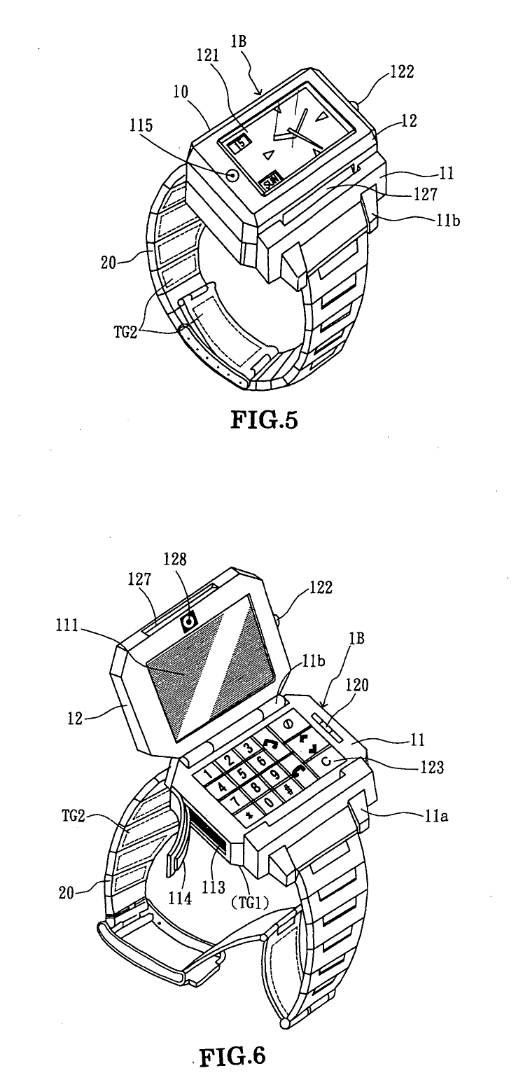

Referring to FIG. 5 and FIG. 6, a wrist-watch mobile phone 1B of a second embodiment of the present invention is provided with a similar basic structure as that of the first embodiment. Therefore, in the context hereinafter, a same symbol will be used to represent a part which is identical or equivalent to that of the first embodiment, and description will be partially omitted. This mobile phone 1B still includes the wrist-watch mobile phone unit 10 and the wrist band 20, wherein the mobile phone unit 10 is provided with the housing 11 and the cover 12. In the first embodiment, the housing 12 is provided at a side end of the wrist-band installation member 11a that is formed with a right angle; whereas, in this embodiment, the cover 12 is provided at a top of the wrist-band installation member 11a of the housing 11 by the hinge 11b without interfering the installation of the wrist band 20 and allowing the cover 12 to be flipped open.

The keyboard 123 is provided on an upper surface of the housing 11, and the interface 113, which is used for recharging transmission, is still provided at one of two ends of the housing 11 without the wrist-band installation member 11a and is sealed by the water-proof rubber strip 114 to prevent from intrusion of dust and rain water. Besides, a speed key 120 is provided in adjacent to the keyboard 123.

A surface of the cover 12 is provided with a quartz-core watch 121, a knob 122 for adjusting time is exposed at one end, just like the configuration of the first embodiment. The other end of the cover 12 and below a watch surface of the quartz watch 121 is provided with the camera lens 115. An inner surface of the cover 12 is provided with the LCD display 111, the free end is provided with the flip groove 127, and a surface between the display 111 and the groove 127 is provided with a video lens (a second camera lens) 128, allowing a face of a talker to be shot into the lens 128 and to be transmitted to a display of a hand phone of the other party of conversation. In this embodiment, portions of the housing 11 and the wrist band 20 that are in contact with a human body are also provided with the thermoelectric power generating chips TG1, TG2 to facilitate recharging the primary and secondary batteries 117, 126 in the hand phone (not shown in the drawings). As the positions of the display 111 and the keyboard 123 is reversed, in other words, the configuration that the display 111 and the keyboard 123 are provided respectively at the housing 11 and the cover 12 in the first embodiment is changed to the configuration that the display 111 and the keyboard 123 are provided respectively at the cover 12 and the housing 11, it is preferable that the main circuit board 125, as shown in FIG. 4, is provided inside the housing 11 instead (not shown in the drawings). On the other hand, an interior of the housing 11 is provided with the primary batter 117 and the SIM card 116; whereas, a side is provided with the interface 113 and the strip 114.

Furthermore, in the second embodiment, the hand phone is not provided with the aforementioned microphone 112 and earphone 124, as this kind of hand phone is not in compliance with ergonomics when used for voice communication (worn on the wrist to receive conversation directly). However, the hand phone is built in with a Bluetooth element and circuit, and when utilizing this kind of hand phone to receive conservation, a wireless Bluetooth microphone and earphone should be used additionally (not shown in the drawings).

### Third Embodiment

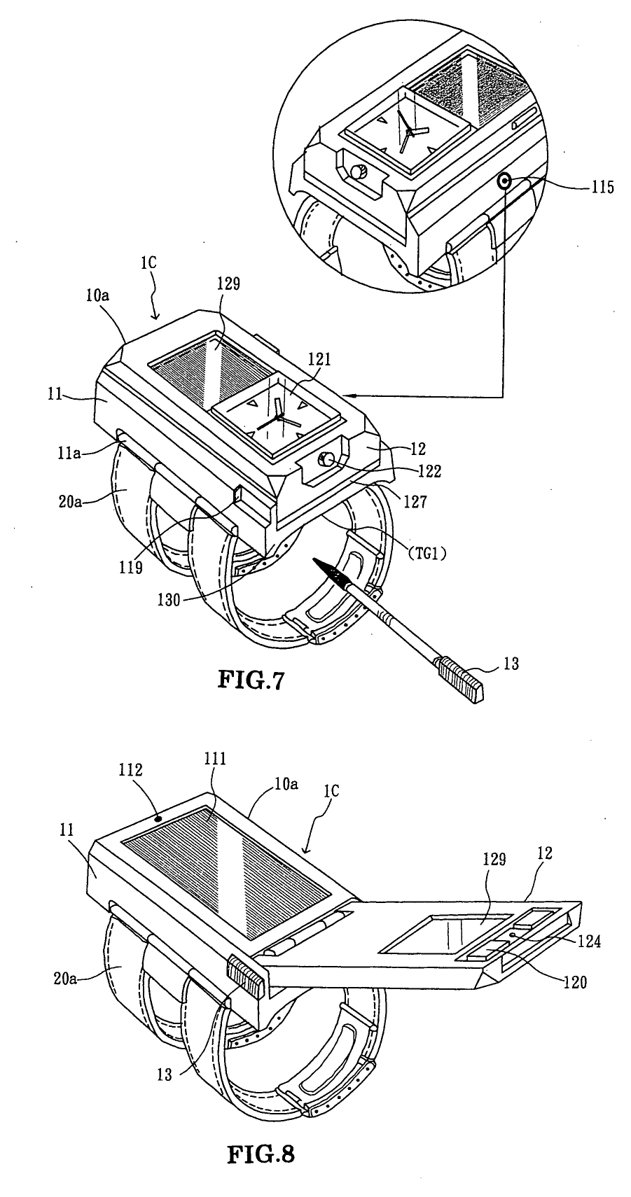

FIG. 7 and FIG. 8 show an embodiment of the present invention applied in a PDA hand phone (or a personal digital assistant mobile phone). A PDA hand phone 1C of a third embodiment is provided with a longer length and large volume due to more versatile functions, a keyboard with more press keys and a large memory; therefore, it is preferable to use a dual-band wrist band structure. The basic structure of the PDA hand phone 1C is roughly same as that of the aforementioned embodiments, except that there are more built-in functional elements than the hand phones in the first and second embodiments. In this embodiment, a same symbol is still used to represent a part which is identical or equivalent to that of each aforementioned embodiment, and description will be omitted.

The PDA hand phone 1C includes a PDA hand phone unit 10a which is provided with the housing 11 and the cover 12, and a wrist band 20a which is fixed at the hand phone unit 10a. A half of a surface of the cover 12 is provided with the quartz-core watch 121, and the other half of the surface is provided with a display window 129 to show year, month, day and a phone number of an incoming call. A groove part formed at a side end of the hinge 11b of the cover 12 is provided with the knob 122 of the quartz watch 121, and the opposite end is provided with the flip groove 127. Furthermore, after flipping open the cover 12, an inner side, close to the free end, is provided with two additional speed keys 120 between which is provided with the earphone 124; whereas, a side surface in adjacent to the display window 129 is provided with a switching key 120a.

A surface of the housing 11 is provided with the liquid crystal display 111, which usually utilizes a horizontal touch keyboard and monitor, allowing a user to use a PDA touch pen 13 to point and touch to dial phone numbers, and to input formation and an operation mode. On the housing 11, in adjacent to the free end, is provided with the microphone 112; whereas, a long side is provided with the camera lens 115. As the housing 11 is longer, it is preferable that the wrist band 20a is made into a dual-band wrist band with leather or metal. In addition, to collect the touch pen 13, a long side of the housing 11 is provided with a longitudinal thin collection hole 119 that the touch pen 13 can be inserted into this hole 119 for collection. To facilitate holding and touching, it is preferable that the touch pen 13 is made into an extensible type that it can be extended upon using and retracted when being collected.

To avoid the signal interruption of the aforementioned PDA hand phone 1C, as the aforementioned embodiments, the bottom surface of the housing 11 is embedded with the thermoelectric power generating chip TG1 which can recharge the battery by the body temperature. A part of the wrist band 20 that is in contact with the wrist can be also embedded with the aforementioned thermoelectric power generating chip TG2, if needed.

### Fourth Embodiment

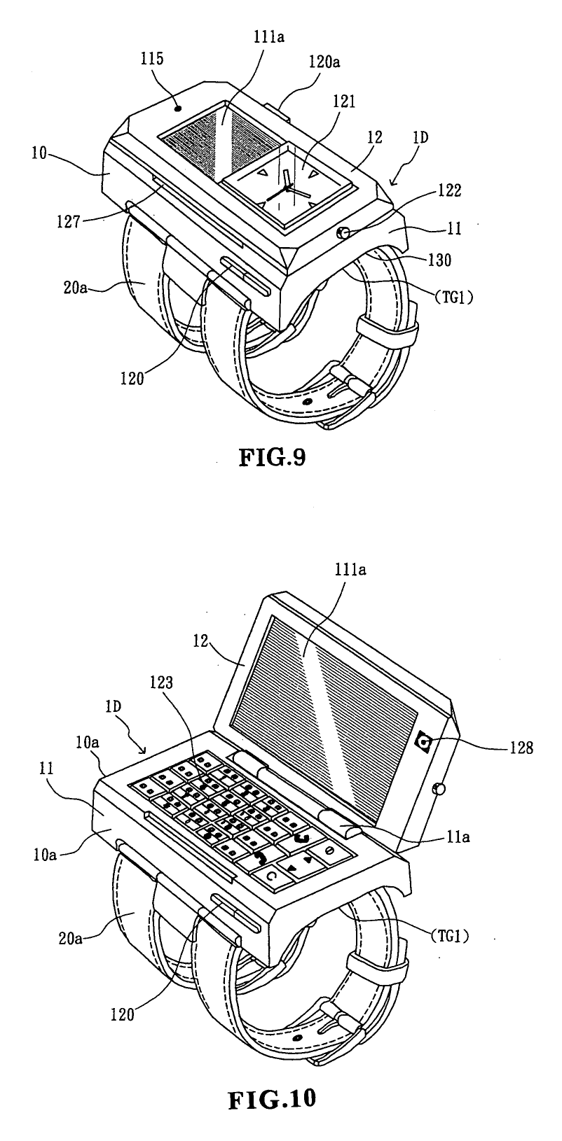

Referring to FIG. 9 and FIG. 10, a fourth embodiment of the present invention is actually a variation of the PDA hand phone 1C of the third embodiment. Therefore, in this embodiment, a same symbol will be used to represent a part that is identical or equivalent to that of the third embodiment.

This PDA hand phone 1D is constituted by the PDA hand phone unit 10a and the wrist band 20a that is fixed at the hand phone unit 10a. The hand phone unit 10a includes the housing 11 and the cover 12 that is pivoted at the housing 11 by the hinge 11b, the cover 12 is provided with the quartz watch 121 and a secondary monitor 111a which is located on a half of a surface of the cover 12. On the other hand, in adjacent to the secondary monitor 111a is provided with the camera lens 115. The secondary monitor 111a can display year, month, day and a phone number of an incoming call by the press key 120a at a side of the housing 12. An inner surface of the housing 12 is provided with the main display 111, and a side is provided with the video lens (a second lens) 128. The knob 122 of the quartz watch 121 is protruded at an end of the housing 11.

Above the housing 11 is provided with the two-word keyboard 123, a side opposite to the hinge 11b is provided with the flip groove 127, and the other side that is adjacent to the groove 127 is provided with the speed key 120a; whereas, a bottom is formed with an inner groove 130 which roughly fits the wrist, with a surface of the groove 130 being embedded with the thermoelectric power generating chip TG1.

The PDA hand phone 1D is not provided with the microphone and the earphone, but the hand phone is built in with a Bluetooth element and circuit. In utilizing this kind of hand phone for communication, a wireless Bluetooth microphone and earphone should be used additionally (not shown in the drawings).

Furthermore, in the aforementioned third and fourth embodiments, an interior of the housing 11 is provided with the SIM card 116, the primary battery 117 and the main circuit board 126; whereas, a side of the housing 11 is provided with the interface 113 for recharging transmission, and the strip 114.

In addition to the specific functions described, depending on a design of each hand phone manufacturer, the mobile phone disclosed by the aforementioned first to fourth embodiment can be optionally built in with any one or more than two functions of Bluetooth, fast internet, data transmission, video conversation, camera, voice recording, audio-video playing, to meet market needs. Besides, the water-proof rubber strip for the opening of recharging interface can be also replaced by a withdrawable or open-close water-proof cap that is integrally assembled with the housing.

The condition of using the wrist-watch mobile phone of the present invention is described hereinafter.

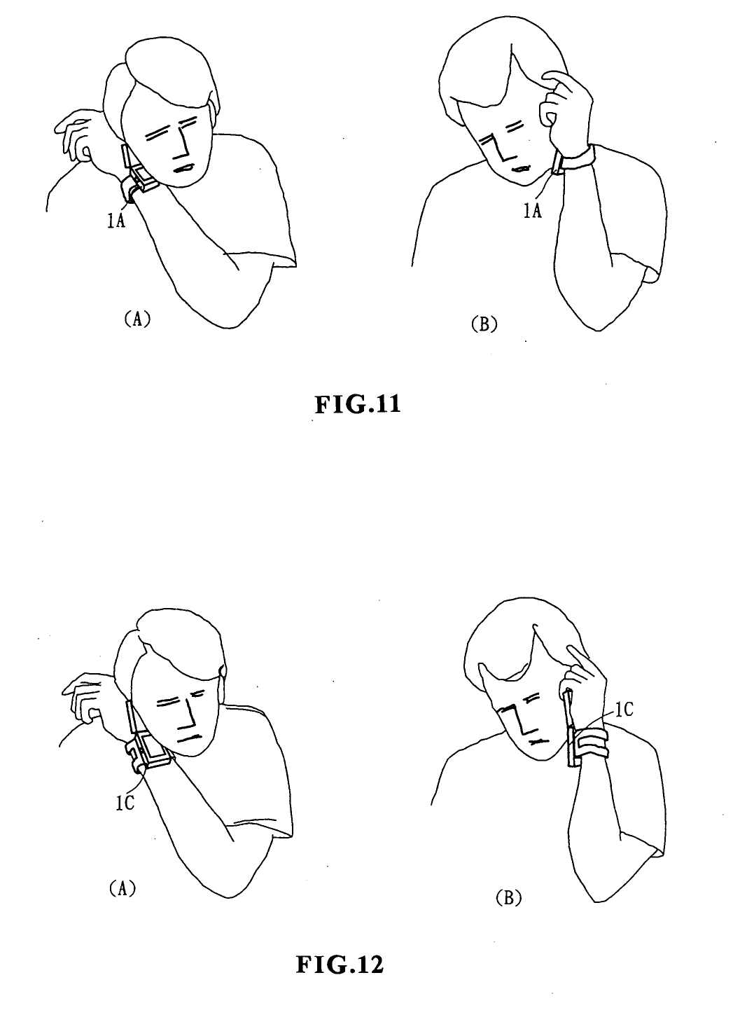

The mobile phone (hand phone) 1A˜1D, according to the first to fourth embodiment, can be worn on the wrist for use with the wrist band 20, 20a like an ordinary watch. As the mobile phone 1A, 1C of the first and third embodiment has already been built in with the microphone and the earphone, the user can wear on the hand to directly answer and call the phone. Due to difference of wearing habit, some people will wear the hand phone on the forward side (or the back side of hand) and others may wear the hand phone reversely (or the front side of hand). FIG. 11(A), (B) and FIG. 12(A), (B) disclose respectively the mobile phone 1A of the first embodiment and the PDA mobile phone 1C of the third embodiment, wherein the mobile phones are worn forwardly and reversely. On the other hand, as the mobile phone 1B, 1D of the second and the fourth embodiment is not built in with the microphone and the earphone, the Bluetooth microphone and earphone should be used additionally. If the mobile phone 1A, 1C of the first and the third embodiment is also built in with the Bluetooth earphone, then the user can optionally use the Bluetooth microphone and earphone to answer and call the phone.

### FUNCTION OF INVENTION

As the wrist-watch mobile phone of the present invention can be worn on the wrist for use, the mobile phone is attached to the body normally, and the mobile phone is built in with the microphone and the earphone to directly receive and transmit voices and image data; hence, the probability that the hand phone and the earphone will be lost can be reduced. On the other hand, for the mobile phone that is not provided with the microphone and the earphone, the probability that the hand phone will be lost can be decreased. As both hands can freely move when wearing the mobile phone, it is suitable for the user who needs to use both hands to work at a same time. Besides, it can also create a fashion. Especially, the hand phone or the wrist band is provided with the thermoelectric power generating chips, such that the hand phone battery can be recharged at any time by the body temperature of arm, which is able to prevent the signals of the hand phone from being interrupted.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wrist-watch mobile phone device comprising a watch-type mobile phone unit which is applied in a wireless communication system, and a wrist band which is removably connected to the mobile phone unit, wherein the mobile phone unit includes a housing which is provided with wrist-band installation members, a cover which is pivoted on the housing and is flipped open with respect to this housing, at least one wireless transmission circuit which is built into the housing and the cover to receive and transmit wireless audio-video signals, a user interface which is used to input signals or to dial phone numbers, a display device which is used to display communication information, and a rechargeable battery; in the housing and the wrist band of the mobile phone unit, at least a bottom of the housing that is in contact with a human wrist being embedded with thermoelectric power generating chips, so as to recharge the aforementioned battery at any time using a current produced by body temperature.

2. The wrist-watch mobile phone device according to claim 1, wherein a surface of the cover of the mobile phone unit is provided with an independent system of an analog quartz-core watch.

3. The wrist-watch mobile phone device according to claim 1 or 2, wherein the mobile phone unit is built in with at least one function of Bluetooth, fast internet, data transmission, camera, video communication and audio-video playing.

4. A wrist-watch PDA mobile phone device comprising a watch-type PDA mobile phone unit which is applied in a wireless communication system and a wrist band which is removably connected to this PDA mobile phone unit, wherein the PDA mobile phone unit includes a housing which is provided with wrist-band installation members, a cover which is pivoted on the housing and is flipped open with respect to the housing, at least one wireless transmission circuit which is built into the housing and the cover to receive and transmit wireless audio-video signals, a user interface which is used to input signals or to dial phone numbers, a display device which is used to display communication information, and a rechargeable battery; in the housing and the wrist band of the PDA mobile phone unit, at least a bottom of the housing that is in contact with a human wrist being embedded with thermoelectric power generating chips, so as to recharge the aforementioned battery at any time using a current produced by body temperature.

5. The wrist-watch PDA mobile phone device according to claim 4, wherein a surface of the cover of the PDA mobile phone unit is provided with an independent system of an analog quartz-core watch.

6. The wrist-watch PDA mobile phone device according to claim 4 or 5, wherein the PDA mobile unit phone is built in with at least one function of Bluetooth, fast internet, data transmission, camera, video communication and audio-video playing.
